(19) United States
(12) Patent Application Publication
(10) Pub. No.: US 2013/0132487 A1
(43) Pub. Date: May 23, 2013

(54) PEER-TO-PEER CONNECTION ESTABLISHMENT METHOD AND SYSTEM

(71) Applicant: SHI-MING ZHAO, TAIPEI CITY (TW)

(72) Inventor: SHI-MING ZHAO, TAIPEI CITY (TW)

(73) Assignee: BLUE RAY TECHNOLOGIES CORP., TAIPEI CITY (TW)

(21) Appl. No.: 13/300,797

(22) Filed: Nov. 21, 2011

(51) Int. Cl. G06F 15/16

(52) U.S. Cl. 709/206; 709/229

(57) ABSTRACT

In a peer-to-peer connection establishment method, processing modules installed at the two peers use a reliable network space as a transmission medium to transmit an online transmission request to the space to obtain channel establishment information from the opposite party, such that data can be communicated between both parties directly via a remote connection to assure the privacy of information, so as to enhance the safety of using a network.

### BACKGROUND OF THE INVENTION

1. Field of the Invention

The present invention relates to an end-point connection method, in particular to a peer-to-peer connection establishment method that installs a connection mechanism at two peers and exchange connection information with each other by using a safe network resource system.

2. Description of the Related Art

Since portable electronic products come with the thin and light features, the portable electronic products have become a useful tool. However, the portable electronic products have the disadvantages of a limitation of the size and a lower performance than personal computers, and thus operating at a remote end through a network is a method that can bring out the advantages of both.

With reference to FIG. 1 for the flow chart of a conventional remote connection, if a client wants to log on a remote computer, the client generally connects to a third-party server on the network (Step S01), and input necessary information for the connection (Step S02), and then the third-party server notifies the client and the remote computer about connection information of both parties (Step S03), and after receiving the notice, each of the client and the remote computer submits a connection request to the opposite party (Step S04) to establish a transmission channel successfully (Step S05). In this remote connection method, a third-party server installed on the network is provided for controlling the connection of the two peers, and information including a connection request, a user account password and a port are transmitted from one peer to the other through the third-party server, or the connection information is saved into a database of the third-party server (Step S06), such that the third-party server has a loophole of the remote connection protection and a concern of computer safety. Particularly, most clients cannot determine whether a third-party server is reliable, and unauthorized people may implant backdoor programs in the third-party server computer or monitor data transmitting via the network to steal data from the client and the remote computer, so that the third-party server has a blind spot of safety protection.

In view of the aforementioned shortcomings of the prior art, the present invention changes the method of controlling the remote connection procedure without consuming additional resources at the client, and performs the remote connection procedure at both peers and uses a reliable network resource as an information transmission medium to protect the privacy of the connection information and enhance the network safety.

### SUMMARY OF THE INVENTION

In view of the shortcomings of the prior art, it is a primary objective of the present invention to provide a peer-to-peer connection establishment method that sets the control end for controlling a procedure at the client end, and selects a reliable network transmission medium to improve the safety of a network connection.

To achieve the aforementioned objective, the present invention provides a peer-to-peer connection establishment method having a distributed authentication mechanism established between two peers, and a reliable mail system used as a transmission medium to exchange information with a stream information channel to assure the privacy of information and improve the safety of using a network, and the peers being coupled and communicated with at least one mail system server, and the peer-to-peer connection establishment method comprising the steps of: converting a format of an online transmission request at a first peer by a first processing module, and transmitting the online transmission request in form of a mail, and the online transmission request including a first communication key and information of the first peer, for establishing an online connection; receiving the online transmission request by a second peer through the mail system server via Internet; converting the format of the online transmission request at the second peer by a second processing module, and the second peer carrying out a channel establishment procedure according to the online transmission request; performing a time calibration of the second peer and a global time server; generating an online transmission acknowledge by the second peer, and converting the format of the online transmission acknowledge by the second processing module, and transmitting the online transmission acknowledge in form of a mail, and the online transmission acknowledge including a second communication key, a predetermined time and connection information of the second peer, for establishing a transmission channel; receiving the online transmission acknowledge by the first peer through the mail system server via the Internet; converting the format of the online transmission acknowledge at the first peer by the first processing module, and carrying out the channel establishment by the first peer according to the online transmission acknowledge; performing a time calibration of the first peer and the global time server to confirm that the time of the first peer is synchronous with the time of the second peer; transmitting a first connection request to the second peer by the first peer, if the predetermined time is reached; transmitting a second connection request to the first peer by the second peer, if the predetermined time is reached; and establishing a connection between the first peer and the second peer; and in the authentication mechanism, the processing modules installed at the two peers transmit the connection request in form of a mail, and obtain connection information of the opposite party through reliable the mail system server, and use the global time server to assure a time synchronization of the two peers, and if the predetermined time is reached, both peers transmit a connection request to the opposite party to establish a transmission channel successfully.

Wherein, the second peer generates an online transmission acknowledge, and converts the format of the online transmission acknowledge by the second processing module, and transmits the online transmission acknowledge in form of a mail, and the online transmission acknowledge includes information of a second communication key, a predetermined time and the second peer connection, and before the procedure of establish the transmission channel takes place, the method further comprises the step of obtaining IP communication information of the second peer by a query server at the second peer, which is included in the online transmission acknowledge and provided for the first peer to establish the transmission channel.

Wherein, the format of an online transmission request is converted by a first processing module at a first peer, and the online transmission request is transmitted in form of a mail, and the online transmission request includes information of a first communication key and the first peer connection, and the method further comprises the step of obtaining IP communication information of the first peer by a query server at the first peer, which is included in the online transmission acknowledge and provided for the second peer to establish the transmission channel.

Wherein, the connection establishment method further comprises the step of using a second network address converter/a second firewall communicated and coupled to a protocol stack of the second peer to turn on a timely connection channel to connect the first peer in the step of transmitting a second connection request from the second peer to the first peer, if the predetermined time is reached.

Wherein, the connection establishment method further comprises the step of using a first network address converter/a first firewall communicated and coupled to a protocol stack of the first peer to turn on a timely connection channel to connect the second peer in the step of transmitting a first connection request from the first peer to the second peer, if the predetermined time is reached.

Wherein, the first peer transmits a first connection request to the second peer, and the first connection request includes performing a countdown of the first peer and the second peer according to the predetermined time if the predetermined time is not reached before step of the second communication key takes place, and carrying out a follow-up procedure of the connection establishment request immediately to establish a transmission channel successfully if the predetermined time is reached.

In another preferred embodiment of the present invention, the peer-to-peer connection establishment method has a distributed authentication mechanism established between two peers, and reliable network resource used as a transmission medium to exchange information with a stream information channel to protect the privacy of information and improve the safety of using a network, and the peers are coupled and communicated with at least one network resource, and the peer-to-peer connection establishment method comprises the steps of: transmitting an online transmission request from a first peer to a second peer through a first processing module, and converting the format of the online transmission request by the first processing module to perform a transmission by using the network resource; performing a time calibration with a global time server by the second peer to generate an online transmission acknowledge after a second processing module receives the online transmission request; transmitting the online transmission acknowledge from the second peer to the first peer through the second processing module, and converting the format of the online transmission acknowledge by the second processing module to perform a transmission by using the network resource; receiving the online transmission acknowledge at the first peer through the first processing module; transmitting a connection request from the peers if the predetermined time is reached; and establishing a connection between the first peer and the second peer.

In a further a preferred embodiment of the present invention, the peer-to-peer connection establishment method has a distributed authentication mechanism established between two peers, and a reliable network resource used as a transmission medium to exchange information with a stream information channel to protect the privacy of information and improve the safety of using a network, and the peers are coupled and communicated with at least one network resource, and the peer-to-peer connection establishment method comprises the following steps: At a first peer, a time calibration is performed with a global time server to generate an online transmission request, and a first processing module is used for transmitting an online transmission request to a second peer, and the first processing module converts the format of the online transmission request for a transmission by using the network resource. At the second peer, a second processing module is provided for receiving the online transmission request, and then a time calibration with a global time server is performed to confirm a time synchronization between the first peer and the second peer and generate an online transmission acknowledge. At the second peer, the second processing module is used to transmit the online transmission acknowledge to the first peer, and the second processing module converts the format of the online transmission acknowledge to perform a transmission by using the network resource. At the first peer, the first processing module receives the online transmission acknowledge, and then the peers transmits a connection request if the predetermined time is reached, and a connection is established between the first peer and the second peer.

To implement the aforementioned connection establishment method, the present invention further provides a peer-to-peer connection establishment system, having a distributed authentication mechanism established between two peers, and a reliable mail system used as a transmission medium to exchange information with a stream information channel to assure the privacy of information and improve the safety of using a network, and the peers being coupled and communicated with at least one mail system server, and the peer-to-peer connection establishment system comprising: a first processing module, installed at a first peer, for assisting the first peer and a second peer at remote end to establish a connection, and the first processing module comprising: a first operating interface, for communicating with a client to receive related data of the second peer and start establishing a transmission channel; a first format converter, for converting an information packet communicated with the second processing module and transmitting the information packet by using a network resource; and a first transceiver, for transmitting and receiving the information packet through the network resource periodically; a second processing module, installed at a second peer, for assisting the second peer and a first peer at a remote end to establish a connection, and the second processing module including: a second format converter, for converting the information packet communicated with the first processing module and transmitting the information packet by using a network resource; and a second transceiver, for transmitting the information packet through the network resource periodically; a global time server, for calibrating the time of the first peer and the second peer to assure a time synchronization of the two peers; at least one network resource, communicated and coupled to the first transceiver and the second transceiver, for transmitting a service of the information packet; and at least one query server is further provided for the two peers to inquire IP communication information of the respective peers and transmit the IP communication information to the opposite party to establish a transmission channel.

With the aforementioned design, the authentication mechanism installed at the client end no longer requires transmitting the connection information of both parties by the third-party server anymore, so as to improve the client's network safety for the operation. The client can select a reliable mail system server as a medium for exchanging connection information to protect the privacy of the connection information and improve the network safety.

### BRIEF DESCRIPTION OF THE DRAWINGS

FIG. 1 is a flow chart of a conventional remote connection establishment method;

FIGS. 2A and 2B show a flow chart of a peer-to-peer connection establishment method in accordance with a preferred embodiment of the present invention;

FIG. 3 is a schematic view of a system structure in accordance with a preferred embodiment of the present invention;

FIG. 4 is a flow chart of a peer-to-peer connection establishment method in accordance with another preferred embodiment of the present invention; and

FIG. 5 is a flow chart of a peer-to-peer connection establishment method in accordance with a further preferred embodiment of the present invention.

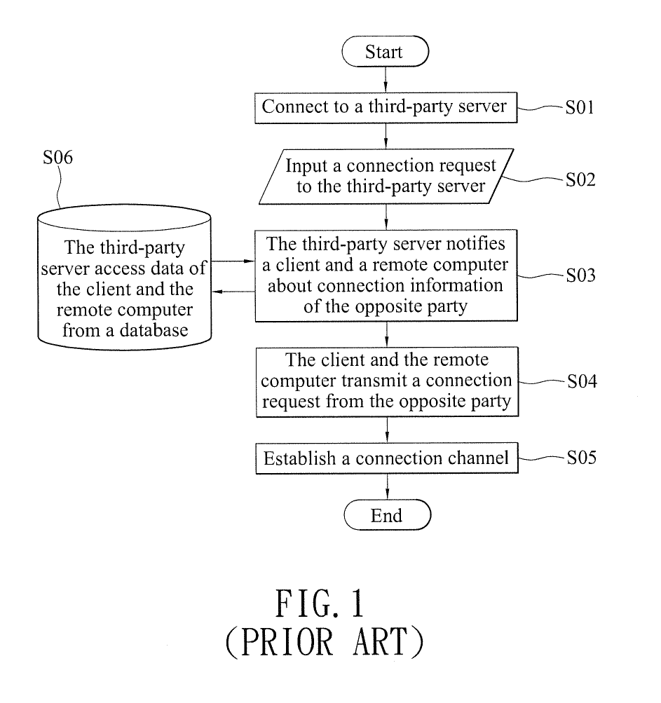

### DETAILED DESCRIPTION OF THE PREFERRED EMBODIMENTS

The technical characteristics of the present invention will become apparent with the detailed description of a preferred embodiment accompanied with the illustration by related drawings as follows.

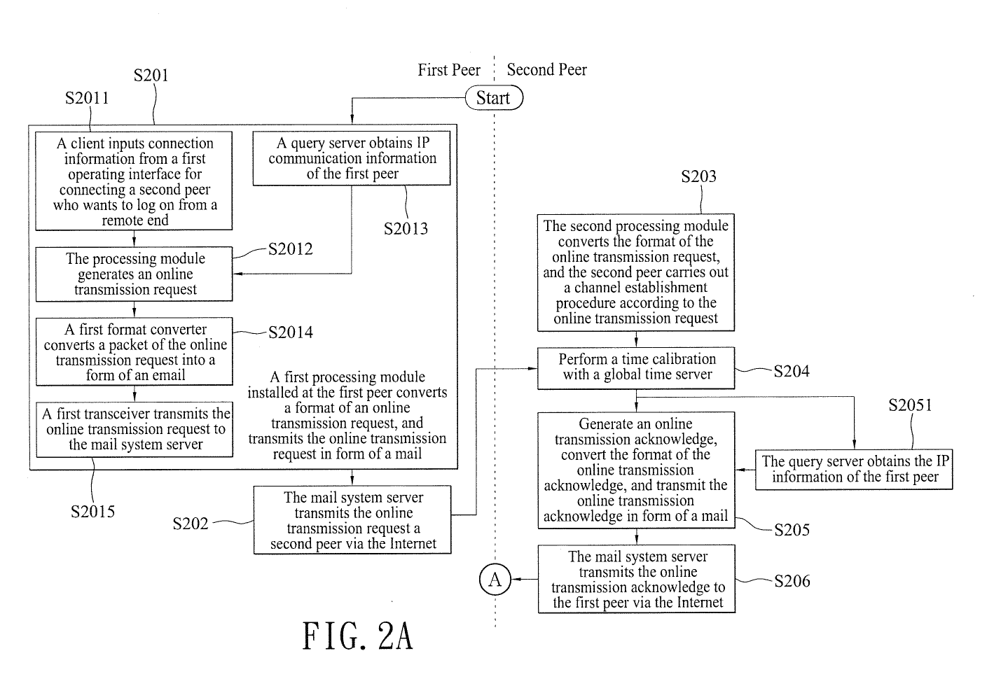

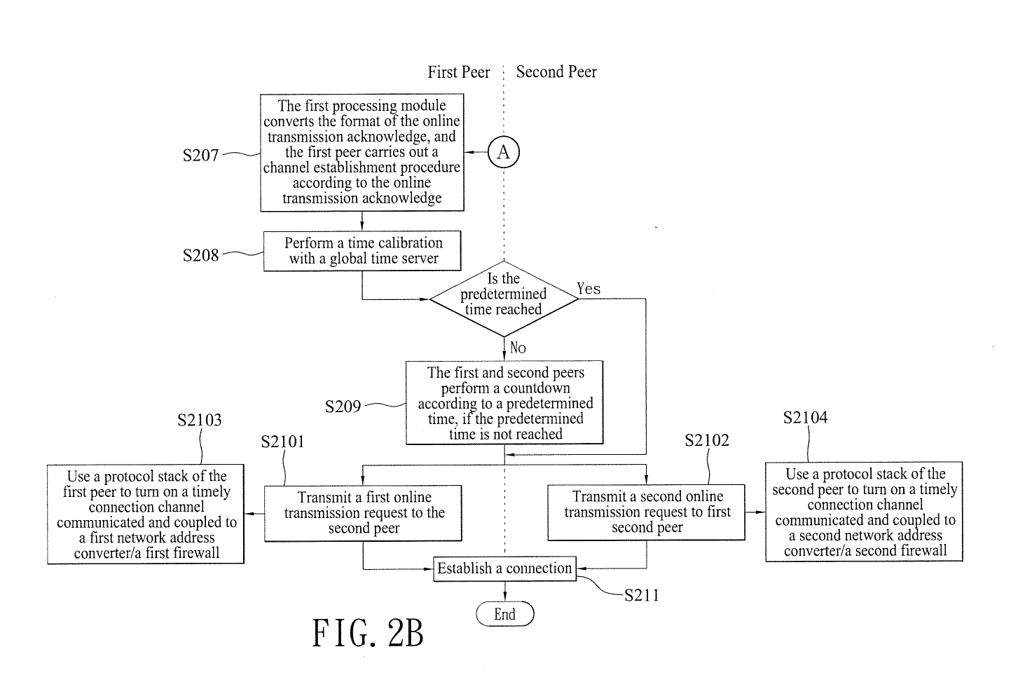

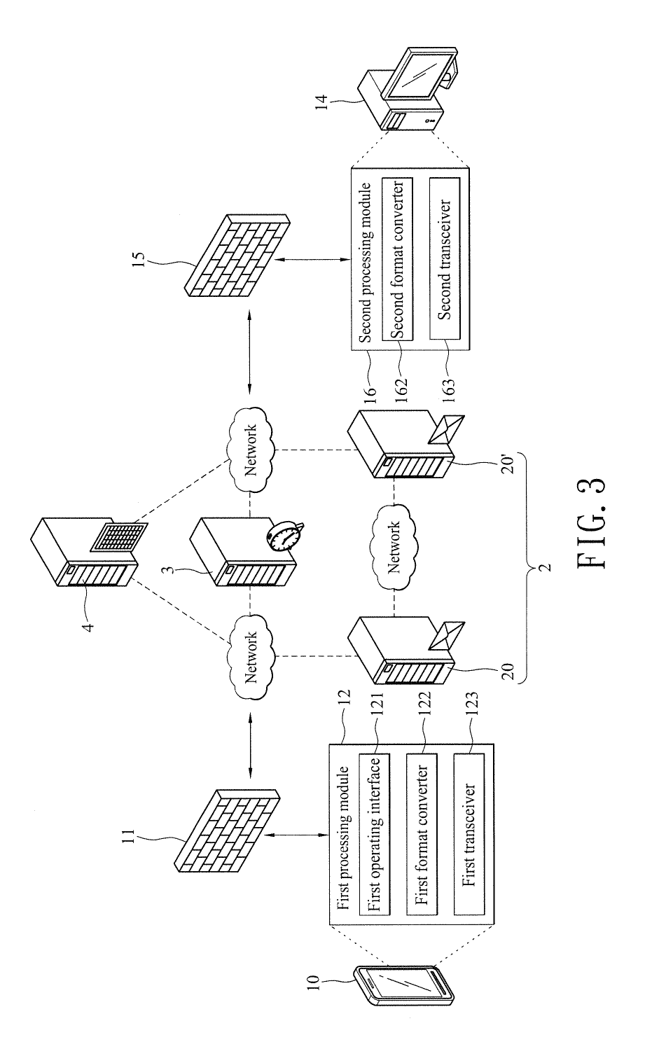

With reference to FIGS. 2A and 2B for a flow chart and FIG. 3 for a schematic view of a peer-to-peer connection establishment method in accordance with a preferred embodiment of the present invention, the peer-to-peer connection establishment method having a distributed authentication mechanism established between two peers, and a reliable mail system used as a transmission medium to exchange information with a stream information channel to protect the privacy of information and improve the safety of using a network, and the peers are coupled and communicated with at least one network resource, and the peer-to-peer connection establishment method comprises the following steps: At a first peer 10, a first processing module 12 installed at the first peer 10 is provided for converting a format of an online transmission request, and transmitting the online transmission request in form of a mail (Step S201). The processing module 12 provides a first operating interface 121 for a client to input connection information from a remote end to log on a second peer 14 (Step S2011), wherein the connection information include information such as email accounts at the client end and at the remote end used for carrying out the procedure of establishing the transmission channel. The processing module 12 assembles the related connection establishment information to form the online transmission request (Step S2012), wherein the connection establishment information includes a first communication key for the authentication for the second peer 14 to establish a connection, and connection information of the first peer 10 such as the information of a physical Internet protocol address (IP Address) provided for the second peer 14 to receive the online transmission request, and then check the first communication key, and establishes the connection according to the connection information and the first peer 10 included in the online transmission request. In a certain situation, if the first peer 10 uses a floating IP or a wireless network, then the first peer 10 obtains IP communication information of the first peer 10 from a query server 4 such as the Internet information query protocol (or WHOIS network protocol) defined by the RFC812, before the online transmission request is generated and included in the online transmission request (Step S2013). A first format converter 122 is provided for converting a packet of the online transmission request into a form of an email (Step S2014). After the format is converted, the online transmission request uses a network resource 2 such as at least one mail system server 20 of this preferred embodiment for the transmission. The first processing module 12 uses a first transceiver 123 to connect the mail system server 20 periodically to transmit and receive an information packet (wherein the time interval for the operation can be set, such as once every five seconds), and the online transmission request is transmitted to the mail system server 20 via the Internet, and to the mail system server 20′ of the second peer 14 by the mail system server 20 (Step S202). The mail system server 20′ and the mail system server 20 can be the same system. For example, both mail system servers 20′, 20 can be the same Gmail accounts developed by Google, or can be two different systems such as a Gmail and a mail system of PChome Online Inc.

The second peer 14 can also be installed with a second processing module 16 to assist the second peer 14 and the first peer 10 to establish a transmission channel. After the online transmission request from the mail system server 20′ is received by a second transceiver 163 of the second processing module 16, a second format converter 162 of the second processing module 16 converts the format of a mail packet, so that the second peer 14 carries out a channel establishment procedure according to the online transmission request (Step S203). In the meantime, the second peer 14 performs a time calibration by using a global time server 3 on the network (Step S204).

The second peer 14 generates an online transmission acknowledge including the information of a second communication key required for authenticating the first peer 10, a predetermined time for opening a connection, and a physical IP address of an end for connecting the second peer 14, provided for the first peer 10 to receive the online transmission acknowledge and then establish a transmission channel with the second peer 14. The packet format of the online transmission acknowledge is converted into a form of email by the second format converter 162, and the second transceiver 163 transmits the online transmission acknowledge to the mail system server 20′ (Step 205). In a certain situation, such as using a floating IP or a wireless network by the second peer 14, and before the online transmission acknowledge is generated, the second peer 14 obtains the IP information of the second peer 14 from the query server 4 and the IP information is included in the online transmission acknowledge (Step S2051). Through the Internet, the mail system server 20′ transmits the online transmission acknowledge to the mail system server 20 communicated and coupled to the first peer 10.

The first transceiver 123 of the first peer 10 periodically transmits a packet of the mail system server 20 to the first processing module 12, and the first format converter 122 converts the format of the online transmission acknowledge, so that the first peer 10 can carry out the channel establishment procedure according to the online transmission acknowledge (Step S207). Firstly, a time calibration between the first peer 10 and the global time server 3 is performed, and the time provided by the global time server 3 is used for confirming a time synchronization between the first peer 10 and the second peer 14 (Step S208).

After the time of the two peers is calibrated, if the predetermined time is not reached, both peers will perform a countdown according to their own predetermined time (Step S209), such that if the predetermined time is reached, the first peer 10 will transmit a first connection request to the second peer 14 immediately (Step S2101), and a protocol stack of the first peer 10 is used for turning on a timely connection channel communicated and coupled to a first network address converter (not shown in the figure)/a first firewall 11 for connecting the second peer 14 (Step S2103). In the meantime, the second peer 14 transmits a second connection request to the first peer 10 (Step S2102) and a protocol stack of the second peer 14 is provided for turning on a timely connection channel communicated and coupled to a second network address converter (not shown in the figure)/a second firewall 15 for connecting the first peer 10 (Step S2104). Due to the Internet transmission features, although both ends can execute the time calibration to confirm a time synchronization, yet the connection requests transmitted from both ends do not necessarily reach the other end at the same time, and a too-large time error of receiving the connection requests may result in failing to establish a transmission channel successfully at a time, so that the first processor 12 and the second processor 16 at both ends will keep sending out the first connection request and the second connection request until the first peer 10 and the second peer 14 establish a connection (Step S211). It is noteworthy to point out that, the network address converters/firewall port can be turned on within a time period. If a connection cannot be established successfully within a time limit due to a network factor or a computer problem, then the port will be shut, and the whole connection process will be restarted from the Step S201.

In the aforementioned authentication mechanism, a necessary procedure for the connection is to install the processing modules 12, 16 at the two peers 10, 14. The invention breaks through the prior art that after the third-party server sends out an instruction, both ends transmit data to the third-party server according to the instruction, and then the mode of creating and transmitting files by the third-party server is processed directly by the processing modules 12, 16 of both ends, so as to enhance the privacy of the remote connection. Further, the connection request is transmitted in form of a mail and provided for the client to selectively use the mail system servers 20, 20′, so that the application not only has a higher flexibility, but the safety of the transmission medium has a better control, and the connection establishment process has a higher reliability. In the process, a free mail system is used as a transmission medium, and the global time server 4 is used for assure the time synchronization between both ends, and the query server is provided for obtaining information such as an IP Address for the connection, so that the transmission channel can be established successfully within a predetermined time without increasing the burden of two peers 10, 14.

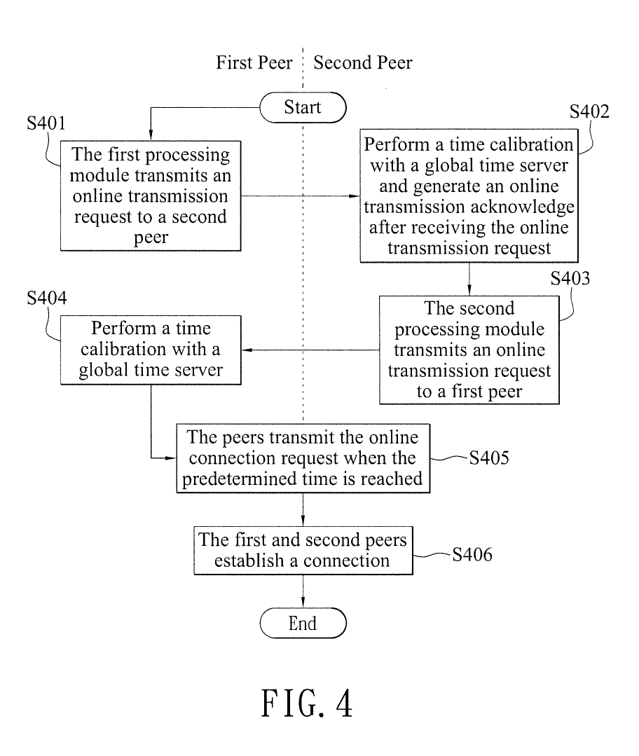

With reference to FIG. 4 for a flow chart of another preferred embodiment of the present invention, the peer-to-peer connection establishment method of the invention not only limits using a mail system server as an information exchange medium, but the network resource 2 also adopts a free-of-charge network hard disk or network space, and the client selects a reliable network resource 2 as a medium for transmitting information. The principle is elaborated by the following procedure: At the first peer 10, the first processing module 12 is provided for transmitting an online transmission request to a second peer 14 (Step S401). The first processing module has the functions of converting the format of the online transmission request format and transmitting the online transmission request to the network resource 2 to perform a transmission by using the network resource 2. After the second peer 14 receives the online transmission request through the second processing module 16 and performs a time calibration with the global time server 3 to generate an online transmission acknowledge (Step S402). The online transmission acknowledge includes necessary information required for establishing a connection, and the second processing module 16 is provided for transmitting the online transmission acknowledge to the first peer 10 (Step S403), wherein the second processing module 16 has the functions of converting the format of the online transmission acknowledge and transmitting the online transmission acknowledge to the network resource 2 to perform a transmission by using the network resource 2. After the first processing module 12 receives the online transmission acknowledge, a time calibration of the first peer 10 and the global time server 3 is performed (Step 5404) to confirm a time synchronization of the first peer 10 and the second peer 14. If the predetermined time is reached, the peers 10, 14 continue transmitting the connection requests (Step S405) until the first peer and the second peer establish a connection (Step S406).

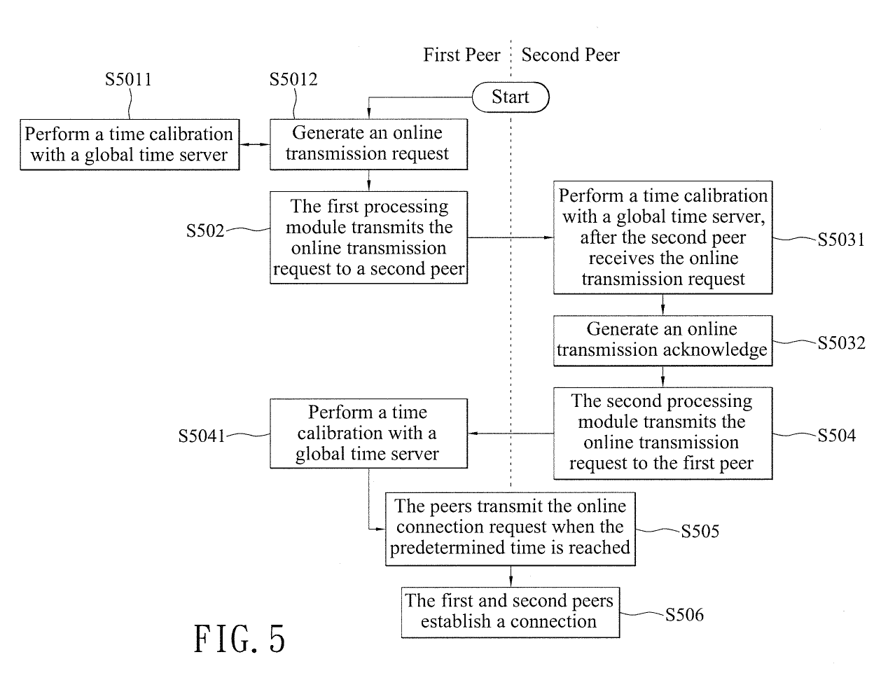

With reference to FIG. 5 for a flow chart of a further preferred embodiment of the present invention, two processors are installed at the two peers to achieve the same effect by the same principle, and the way and sequence of confirm the time synchronization are not limited to those described in this embodiment.

At a first peer 10, a time calibration with a global time server 3 is performed (Step S5011), and an online transmission request is generated (Step S5012), and a first processing module 12 is provided for transmitting an online transmission request to a second peer 14 (Step S502), and the first processing module 12 converts the format of the online transmission request and uses the network resource 2 such as a server for the transmission. At the second peer 14, a second processing module 16 is provided for receiving the online transmission request, and then a time calibration with a global time server 3 is performed (Step S5031) to confirm the time synchronization between the first peer 10 and the second peer 14 and generate an online transmission acknowledge (S5032). At the second peer 14, the second processing module 16 is provided for transmitting the online transmission acknowledge to the first peer 10 (Step S504), and the second processing module 16 converts the format of the online transmission acknowledge and performs a transmission by using the network resource 2. At the first peer 10, the first processing module 12 is provided for receiving the online transmission acknowledge, and when the predetermined time is reached, the peers transmit the connection requests (Step S505) until the first peer 10 and the second peer 14 establish a connection (Step S506). To assure the time synchronization of the two peers, after the first processing module 12 receives the online transmission acknowledge (or after the Step S504 takes place), a time calibration of the first peer 10 and the global time server 3 is performed (Step S5041) for a reconfirmation.

With the design of the present invention and designated programs installed at both ends for establishing a connection, the programs can be used for controlling the whole procedure of the transmission channel establishment actively without receiving the instruction from the third-party server to transmit information of this end to the third-party server passively. A reliable network resource is selected and used as a transmission medium, not only saving the resources of a client computer, but also controlling and protecting the privacy of transmitted data. Therefore, a client simply needs to install the designed application programs to use the portable electronic device to control a computer at office or at home from a remote end via a wireless network.

What is claimed is:

1. A peer-to-peer connection establishment method, having a distributed authentication mechanism established between two peers, and a reliable mail system used as a transmission medium to exchange information with a stream information channel to assure the privacy of information and improve the safety of using a network, and the peers being coupled and communicated with at least one mail system server, and the peer-to-peer connection establishment method comprising the steps of:
converting a format of an online transmission request at a first peer by a first processing module, and transmitting the online transmission request in form of a mail, and the online transmission request including a first communication key and information of the first peer, for establishing an online connection;
receiving the online transmission request by a second peer through the mail system server via Internet;
converting the format of the online transmission request at the second peer by a second processing module, and the second peer carrying out a channel establishment procedure according to the online transmission request;
performing a time calibration of the second peer and a global time server;
generating an online transmission acknowledge by the second peer, and converting the format of the online transmission acknowledge by the second processing module, and transmitting the online transmission acknowledge in form of a mail, and the online transmission acknowledge including a second communication key, a predetermined time and connection information of the second peer, for establishing a transmission channel;
receiving the online transmission acknowledge by the first peer through the mail system server via the Internet;
converting the format of the online transmission acknowledge at the first peer by the first processing module, and carrying out the channel establishment by the first peer according to the online transmission acknowledge;
performing a time calibration of the first peer and the global time server to confirm that the time of the first peer is synchronous with the time of the second peer;
transmitting a first connection request to the second peer by the first peer, when the predetermined time is reached;
transmitting a second connection request to the first peer by the second peer, when the predetermined time is reached; and
establishing a connection between the first peer and the second peer;
and in the authentication mechanism, the processing modules installed at the two peers transmit the connection request in form of a mail, and obtain connection information of the opposite party through reliable the mail system server, and use the global time server to assure a time synchronization of the two peers, and when the predetermined time is reached, both peers transmit a connection request to the opposite party to establish a transmission channel successfully.

2. The connection establishment method of claim 1, wherein the second peer generates an online transmission acknowledge, and converts the format of the online transmission acknowledge by the second processing module, and transmits the online transmission acknowledge in form of a mail, and the online transmission acknowledge includes information of a second communication key, a predetermined time and the second peer connection, and before the procedure of establish the transmission channel takes place, the method further comprises the step of obtaining IP communication information of the second peer by a query server at the second peer, which is included in the online transmission acknowledge and provided for the first peer to establish the transmission channel.

3. The connection establishment method of claim 1, wherein the format of an online transmission request is converted by a first processing module at a first peer, and the online transmission request is transmitted in form of a mail, and the online transmission request includes information of a first communication key and the first peer connection, and the method further comprises the step of obtaining IP communication information of the first peer by a query server at the first peer, which is included in the online transmission acknowledge and provided for the second peer to establish the transmission channel.

4. The connection establishment method of claim 2, wherein the format of an online transmission request is converted by a first processing module at a first peer, and the online transmission request is transmitted in form of a mail, and the online transmission request includes information of a first communication key and the first peer connection, and the method further comprises the step of obtaining IP communication information of the first peer by a query server at the first peer, which is included in the online transmission acknowledge and provided for the second peer to establish the transmission channel

5. The connection establishment method of claim 1, further comprising the step of using a second network address converter/a second firewall communicated and coupled to a protocol stack of the second peer to turn on a timely connection channel to connect the first peer in the step of transmitting a second connection request from the second peer to the first peer, when the predetermined time is reached.

6. The connection establishment method of claim 1, further comprising the step of using a first network address converter/a first firewall communicated and coupled to a protocol stack of the first peer to turn on a timely connection channel to connect the second peer in the step of transmitting a first connection request from the first peer to the second peer, when the predetermined time is reached.

7. The connection establishment method of claim 1, wherein the first peer transmits a first connection request to the second peer, and the first connection request includes performing a countdown of the first peer and the second peer according to the predetermined time when the predetermined time is not reached before step of the second communication key takes place, and carrying out a follow-up procedure of the connection establishment request immediately to establish a transmission channel successfully when the predetermined time is reached.

8. A peer-to-peer connection establishment system, having a distributed authentication mechanism established between two peers, and reliable network resource used as a transmission medium to exchange information with a stream information channel to assure the privacy of information and improve the safety of using a network, and the peers being coupled and communicated with at least one network resource, and the peer-to-peer connection establishment system comprising:
a first processing module, installed at a first peer, for assisting the first peer and a second peer at remote end to establish a connection, and the first processing module comprising:
a first operating interface, for communicating with a client to receive related data of the second peer and start establishing a transmission channel;
a first format converter, for converting an information packet communicated with the second processing module and transmitting the information packet by using a network resource; and
a first transceiver, for transmitting and receiving the information packet through the network resource periodically;
a second processing module, installed at a second peer, for assisting the second peer and a first peer at a remote end to establish a connection, and the second processing module including:
a second format converter, for converting the information packet communicated with the first processing module and transmitting the information packet by using a network resource; and
a second transceiver, for transmitting the information packet through the network resource periodically;
a global time server, for calibrating the time of the first peer and the second peer to assure a time synchronization of the two peers; and
at least one network resource, communicated and coupled to the first transceiver and the second transceiver, for transmitting a service of the information packet.

9. The connection establishment system of claim 8, further comprising at least one query server, provided for the two peers to inquire IP communication information of the respective peers and transmit the IP communication information to the opposite party to establish a transmission channel.

10. A peer-to-peer connection establishment method, having a distributed authentication mechanism established between two peers, and a reliable network resource used as a transmission medium to exchange information with a stream information channel to assure the privacy of information and improve the safety of using a network, and the peers being coupled and communicated with at least one network resource, and the peer-to-peer connection establishment method comprising the steps of:
transmitting an online transmission request from a first peer to a second peer through a first processing module, and converting the format of the online transmission request by the first processing module to perform a transmission by using the network resource;
performing a time calibration with a global time server by the second peer to generate an online transmission acknowledge after a second processing module receives the online transmission request;
transmitting the online transmission acknowledge from the second peer to the first peer through the second processing module, and converting the format of the online transmission acknowledge by the second processing module to perform a transmission by using the network resource;
receiving the online transmission acknowledge at the first peer through the first processing module;
transmitting a connection request from the peers when the predetermined time is reached; and
establishing a connection between the first peer and the second peer.

11. The connection establishment method of claim 10, further comprising the step of performing a time calibration of the first peer and the global time server by the first peer, before the step of using a first processing module to transmit an online transmission request to a second peer, and converting the format of the online transmission request to perform a transmission by using the network resource.

12. The connection establishment method of claim 11, further comprising the step of performing a time calibration with the global time server by the first peer further to confirm a time synchronization of the first peer and the second peer after the step of receiving the online transmission acknowledge by the first processing module.
